(19) United States
(12) Patent Application Publication
(10) Pub. No.: US 2008/0232514 A1
(43) Pub. Date: Sep. 25, 2008

(54) GPS signal acquisition circuit

(75) Inventor: Oliver Huang, Hsinchu City (TW)

Correspondence Address: COOPER & DUNHAM, LLP, 1185 AVENUE OF THE AMERICAS, NEW YORK, NY, 10036, US

(73) Assignee: SkyTraq Technology Inc.

(21) Appl. No.: 11/726,618

(22) Filed: Mar. 22, 2007

(51) Int. Cl. H04L 27/06

(52) U.S. Cl. 375/343

(57) ABSTRACT

A GPS signal acquisition circuit includes a correlation engine, a decimator, a coherent integrator and an incoherent integrator. An over sampled GPS signal is fed into and processed by the correlation engine. The processed signal is sent to the decimator. The decimator generates an output for every M input from the correlation engine. When the decimated correlation engine output is processed in subsequent coherent and incoherent accumulations, the size of the memory required for high-sensitivity signal processing is greatly reduced. Therefore, the production cost can be lowered significantly.

### BACKGROUND OF THE INVENTION

1. Field of the Invention

The invention relates to a GPS signal acquisition circuit. In particular, the GPS signal acquisition circuit only requires low memory storage to perform coherent and incoherent integrations of the GPS signals and maintain high signal sensitivity.

2. Description of Related Art

FIG. 2 shows a system block diagram of a conventional GPS receiver. According to the processing procedures, the signal goes through an antenna, a pre-amplifier, a front end, an analog-to-digital converter (ADC), a digital signal processing unit, a navigation processing unit to generate coordinate information, which is then presented to the user through an appropriate user interface.

As shown in FIG. 3, the GPS signal received by the receiver is processed and output by a correlation engine in forms of several frames. The time associated with each frame is 1 msec. The number of samples contained in a frame is a multiple 1023. Given the input signal is correlated with a correct PN code, the output of the correlation engine in each frame will have a correlation peak; when the signal to noise ratio is low, the correlation peak will be obscured. The correlation peak signal can be positive or negative (as indicated by the arrows P). To detect the value and position of the peaks, the GPS receiver employs the structure given in FIG. 4.

To have high sensitivity, the input signal is over sampled and output of the matched filter correlation engine 60, as shown in FIG. 4, is also an over sampled signal. For example, the sampled signal may have four times the nominal frequency of the GPS PN code chip rate; that is, each frame has 4092 sampled values. The signal is then sent to a coherent integrator 61 for accumulation. The coherent integrator 61 accumulates a specific amount of frames to obtain a coherent integration signal sumX (X=1 . . . n). For example, FIG. 5 shows that each four frames (fram1˜frame4), (frame5˜frame8) is individually accumulated to obtain several coherent integration signals (sum1, sum2, . . . ).

The coherent integration signals (sum1, sum2, . . . ) output by the coherent integrator 61 can be further processed by an absolute-value circuit (ABS) before being sent to an incoherent integrator 62. The absolute-value circuit ensures that the data do not cancel each other out while doing the incoherent integrations due to their positive and negative nature. As shown in the drawing, the coherent integration signals (sum1, sum2, . . . ) are accumulated by the incoherent integrator 62 to generate an incoherent integration signal. The peak signal can be readily extracted from the incoherent integration output for subsequent signal processing.

Under the above-mentioned structure, to detect weak signals contained in the over sampled data output by the matched filter correlation engine 60, either the coherent integrator 61 or the incoherent integrator 62, have to possess a high memory storage to execute the data accumulation. For example, the coherent integrator 61 has to use 4092 word×12 bit of memory. The incoherent integrator 62 has to use 4092 word×20 bit of memory.

Moreover, the signal processing of the GPS receiver often utilizes multiple sets of such search engine in parallel to speed up acquisition of weak signals. In other words, multiple groups of coherent integrators 61 and incoherent integrators 62 are used; multiple groups of large memory storage units are needed in making of a GPS receiver chip, and the cost is relatively high.

### SUMMARY OF THE INVENTION

In view of the foregoing drawbacks, an objective of the invention is to reduce memory requirement in GPS signal processing while maintaining high sensitivity in signal detection. It is desirable to use only low memory storage to accomplish the coherent and incoherent integration processing for the GPS signal, and still be able to detect weak signal and its offset position.

To achieve the above-mentioned objective, the invention includes: a correlation engine, a decimator, a coherent integrator and an incoherent integrator.

The correlation engine outputs a correlation-processed GPS signal. The signal is grouped into several periodic frames. Each frame has N×1023 sampled values.

The decimator sums M samples coming out of the correlation engine and output the summed result for further processing by the coherent integrator; M is a divisor of N×1023. Then the number of samples within a frame period in the decimated output is reduced by a factor of M, and the number of words of memory required for subsequent coherent and incoherent processing is greatly reduced.

The coherent integrator performs coherent accumulation of the decimated output and generates a coherently integrated signal.

The incoherent integrator performs incoherent accumulation of the coherently integrated signals to produce an incoherently integrated signal.

By inserting a decimator between the correlation engine and the coherent integrator, the data size for subsequent computation can be greatly reduced. The coherent integrator and the incoherent integrator use a much smaller amount of memory to accomplish the data accumulation tasks. The value and position of the weak peak can still be detected.

### BRIEF DESCRIPTION OF THE DRAWINGS

FIG. 1 is a block diagram of an embodiment of the invention;

FIG. 2 is a system block diagram of a conventional GPS receiver;

FIG. 3 is shows output waveform of the correlation engine when the signal is weak;

FIG. 4 shows prior art processing structure for the high sensitivity search engine consisting of matched filter correlation engine, coherent integrator, and incoherent integrator inside a GPS receiver;

FIG. 5 is a figure showing the coherent integration and incoherent integration processing within a conventional GPS receiver search engine.

### DETAILED DESCRIPTION OF THE PREFERRED EMBODIMENT

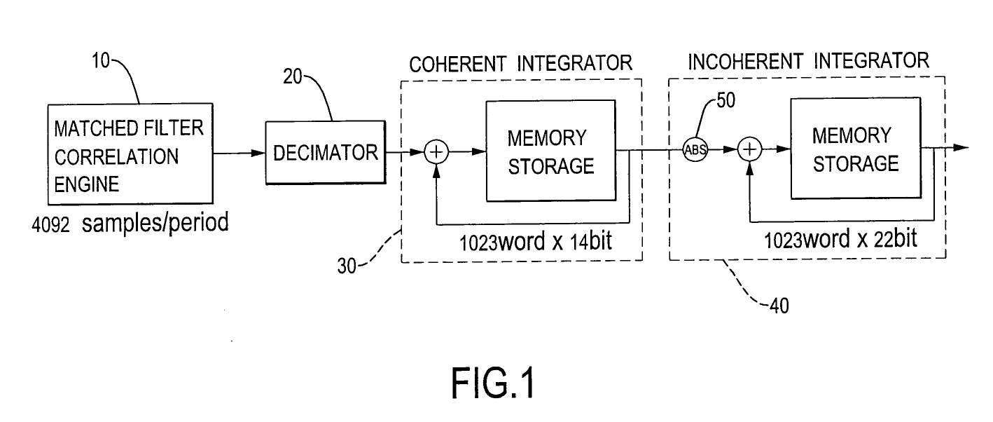

A circuit block diagram of a first embodiment is shown in FIG. 1. The circuit includes a matched filter correlation engine 10, a decimator 20, a coherent integrator 30, and an incoherent integrator 40.

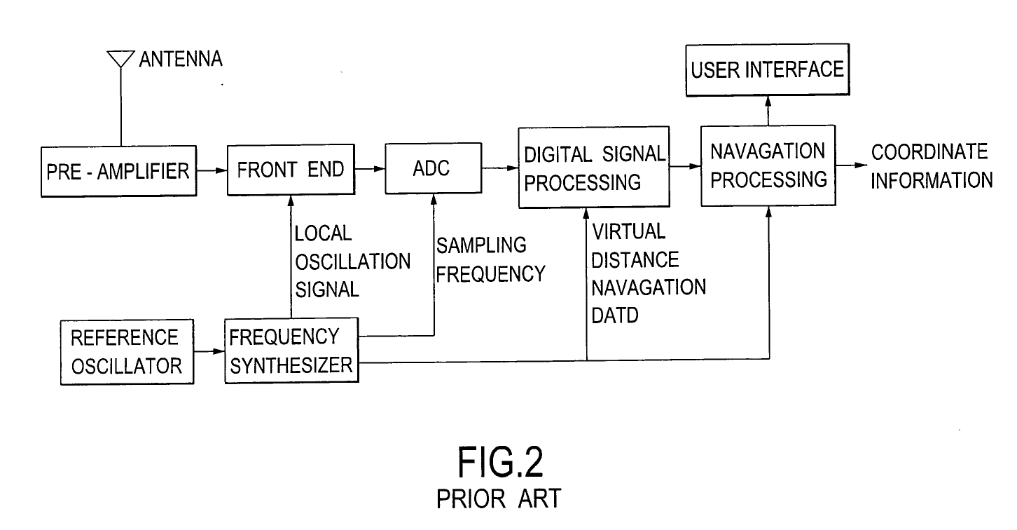

GPS signal coming off a GPS satellite consists of 1.023 MHz pseudo-random (PN) code being modulated by 50 Hz data bit and translated to a carrier frequency of 1575.42 MHz. Each satellite has a unique PN code with period of 1023 chips. A typical GPS receiver, as shown in FIG. 2, first down-converts and amplifies the very weak GPS signal to a signal level suitable to be quantized by the analog-to-digital converter (ADC).

Within the digital signal processing section of the GPS receiver baseband, remaining carrier frequency offset is removed and PN code offset is to be found to formulate the pseudo-range equation in order to resolve position of the GPS receiver. To detect the correct code offset, it is done traditionally using a serial correlator. The serial correlator sequentially correlates a locally generated PN code with the incoming signal. If the signal is strong, correlating for one period of PN code of 1 millisecond would generate a large value in the correlator output when phase of locally generated PN code matches the phase of same PN code embedded in the incoming signal. If the result is less than a pre-determined threshold, the locally generated PN code is shifted 1 chip and the serial correlator correlates for another PN code period of 1 millisecond repeatedly until accumulated value larger than the pre-determined threshold is found. The signal is then declared detected and the code phase offset is used to formulate pseudo-range value.

A sequential correlator typically searches for one code phase each millisecond with presence of strong signal. Since there are 1023 possible code phases with the GPS PN code, it could take up to 1.023 second to search through all 1023 code phases. When the received signal is weak, coherent integration of N millisecond is required for signal detection (N=1 . . . 10); and the search speed becomes 11N. For signal weaker than possibly detectable using coherent integration, combination of coherent integration and incoherent integration must be used; and the search process then becomes very long.

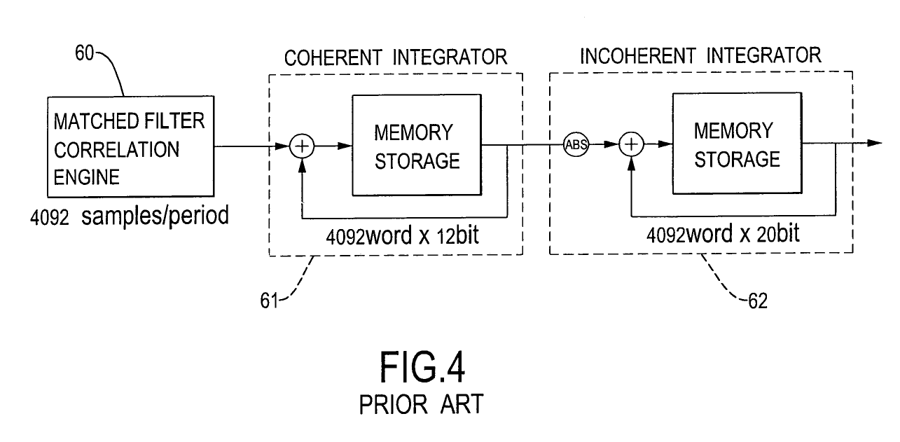

There is match-filter type of parallel correlator architecture that is capable of searching all 1023 code phases per millisecond and yielding speed up of nearly a thousand-fold. The matched filter, with the coherent integrator 61, and the incoherent integrator 62, as shown in FIG. 4, forms a search engine typically found in a high-sensitivity GPS receiver.

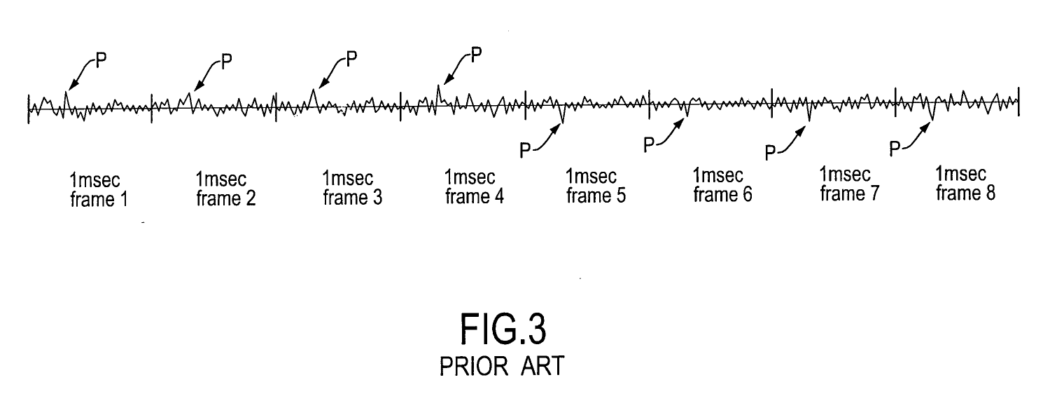

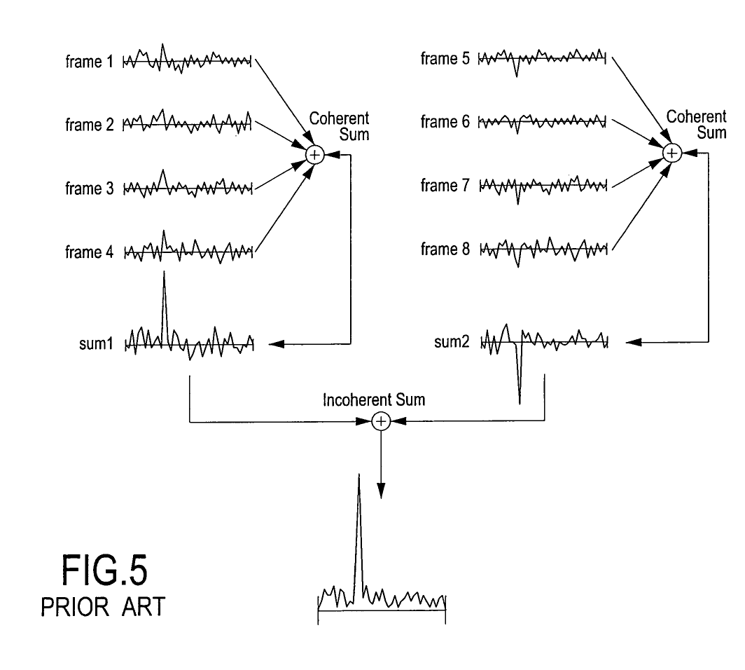

When the signal is weak, the correlation peak in the matched filter correlation engine output is nearly buried in noise. Since the noise in successive 1-millisecond frames is uncorrelated but the correlation peak is correlated, adding successive frames together in place and integrating coherently will reinforce the correlation peak but lower variance of the noise, which makes the correlation peak more detectable. Due to 20-millisecond data bit modulation, coherent integration processing is usually performed for up to 10 milliseconds. If the signal is still too weak to be detectable after the coherent integration processing, an incoherent integration by removing sign-effect of the data bit on the coherently summed output and adding the successive incoherent integrator output will further reinforce the correlation peak. Example showing how coherent integration and incoherent integration reinforce the weak correlation peak in the matched filter correlation engine output of FIG. 3 is shown in FIG. 5.

To achieve high sensitivity, the GPS signal is over sampled and correlated with over sampled version of the PN code sequence within the matched filter correlation engine, and then the over sampled correlated result is output for further processing. Over sampling by factor of 2 or 4 requires 2-times or 4-times the storage space in subsequent coherent and incoherent signal processing, which is quite significant.

To reduce subsequent memory storage requirement, output of correlation engine processed GPS signal, containing N×1023 samples per millisecond within a PN code period, is connected to a decimator 20 circuit. The decimator 20 sums M samples coming out of the correlation engine 10 and outputs the summed result for further processing by the coherent integrator 30 and the incoherent integrator 40; M is a small divisor of N×1023. Then the number of samples within a frame period in the decimated output is reduced by the factor of M, and the number of words of memory required for subsequent coherent and incoherent processing is greatly reduced.

In FIG. 1, the coherent integrator 30 is connected to the output of the decimator 20. Input with reduced sampling rate is accumulated coherently to generate a coherent integration output. The incoherent integrator 40 is connected to the output of the coherent integrator 30. The sample rate reduced coherently integrated output is incoherently accumulated to generate an incoherent integration output.

With respect to FIG. 1, by inserting a decimator 20 between the matched filter correlation engine 10 and the coherent integrator 30, the data size for subsequent computation is reduced significantly. The coherent integrator 30 and the incoherent integrator 40 require a much smaller amount of memory to accomplish the data accumulation tasks; yet value and position of the weak peak can still be detected with high sensitivity. For example, if the input/output (I/O) of the matched filter correlation engine 10 is 4× over sampling (N=4), each frame comprises 1023×4=4092 values. If the decimator 20 generates one summed result every 4 samples (M=4), then the coherent integrator input has only 1023 values per 1 millisecond of PN code frame. The coherent integrator 30 therefore only needs 1023 word×14 bit of memory. The memory required by the subsequent incoherent integrator 40 is 1023 word×22 bit. The total memory required is 1023 words×36 bits.

In addition to the above-mentioned accumulation method, the decimator 20 can accomplish using additional operations. For example, the accumulated result can be further divided by 2 or by 4. In such cases, the result can be represented with fewer bits. The absolute circuit 50 to remove effect of data bit modulation may also be replaced with some other equivalent circuit that removes the sign; one possibility is a squaring circuit.

In the prior art shown in FIG. 4, the coherent integrator 61 requires 4092 word×12 bit of memory, and the incoherent integrator 62 requires 4092 word×20 bit of memory. The total memory is as high as 4092 words×32 bits. In comparison with the present invention shown in FIG. 1, the prior art has 3.56 times the memory requirement of the present invention (1023 words×36 bits). Therefore, the invention can save a significant amount of memory while maintaining high sensitivity to detect weak GPS signal. This can greatly reduce the cost of a high-performance high-sensitivity GPS receiver.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A GPS signal acquisition circuit with reduced memory requirement comprising:
a matched filter correlation engine;
a decimator connected to the output of the matched filter correlation engine;
a coherent integrator connected to the output of the decimator; and
an incoherent integrator connected to the output of the coherent integrator.

2. The GPS signal acquisition circuit as claimed in claim 1, wherein the matched filter correlation engine operates on over sampled GPS signal, capable of searching all PN code phases within 1 millisecond, and generating correlation results comprising consecutive frames each having N×1023 sampled values within the 1 millisecond PN code period; N is an integer.

3. The GPS signal acquisition circuit as claimed in claim 1, wherein the decimator reduces data rate of output of the matched filter correlation engine by a factor of M, and generates one output for every M inputs; M is an integer divisor of N×1023.

4. The GPS signal acquisition circuit as claimed in claim 1, wherein the coherent integrator receives output of the decimator, performs coherent accumulation at reduced sample rate and generates a coherently integrated output, where the coherent integrator has N×1023/M words or storage.

5. The GPS signal acquisition circuit as claimed in claim 1, wherein the incoherent integrator receives coherent output of the coherent integrator and performs incoherent accumulation on the coherent output to generate an incoherently integrated output, where the incoherent integrator has N×1023/M words of storage.

6. The GPS signal acquisition circuit as claimed in claim 2, wherein the decimator reduces the data rate of output of the matched filter correlation engine by a factor of M, and generates one output for every M inputs; M is an integer divisor of N x1023.

7. The GPS signal acquisition circuit as claimed in claim 6, wherein the coherent integrator receives output of the decimator, performs coherent accumulation at reduced sample rate and generates a coherently integrated output, where the coherent integrator has N×1023/M words or storage.

8. The GPS signal acquisition circuit as claimed in claim 7, wherein the incoherent integrator receives coherent output of the coherent integrator and performs incoherent accumulation on the coherent output to generate an incoherently integrated output, where the incoherent integrator has N×1023/M words of storage.
